(19) United States
(12) Patent Application Publication
(10) Pub. No.: US 2014/0136293 A1
(43) Pub. Date: May 15, 2014

(54) RELATIVE TREND ANALYSIS OF SCENARIOS

(71) Applicants: RAGHURAMAN RAMAKRISHNAN, Bangalore (IN); GOWDA TIMMA RAMU, Bangalore (IN)

(72) Inventors: RAGHURAMAN RAMAKRISHNAN, Bangalore (IN); GOWDA TIMMA RAMU, Bangalore (IN)

(21) Appl. No.: 13/672,705

(22) Filed: Nov. 9, 2012

(51) Int. Cl. G06Q 10/06

(52) U.S. Cl. CPC G06Q 10/06375
USPC 705/7.37

(57) ABSTRACT

To perform a relative trend analysis of a business scenario, a graphical illustration of a trend for a business scenario under analysis is displayed on a user interface. The user interface renders and receives a user selection of one or more parameters associated with the business scenario under analysis. Based on the user selection, a database is queried to determine trend-splits of the business scenario under analysis. The trend-splits of the business scenario under analysis are matched with one or more gradient-splits of other business scenarios residing in a database. Based on the matching, the related business scenarios are determined and the gradient-splits of the related business scenarios are retrieved from the database. A graphical illustration of the trend of business scenario under analysis and gradient of the related business scenarios is rendered on the user interface.

### BACKGROUND

Analyzing business scenarios is essential to acquire an insight into the elements influencing the scenarios. Information aggregated over a period of time may play a significant role in establishing an associated scenario. This information associated with the scenario may be presented to an end user in different formats including but not limited to business analytics, business reports, emails, blogs, web pages, newsletters, presentations, or other consumable digital forms. Aggregating such information presented in different formats may result in an unstructured representation of business data. Such unstructured information may undergo eventual changes depending upon events influencing an associated scenario. Analyzing the eventual changes helps in understanding past influencing events along with future anticipated events.

### BRIEF DESCRIPTION OF THE DRAWINGS

The claims set forth the embodiments with particularity. The embodiments are illustrated by way of examples and not by way of limitation in the figures of the accompanying drawings in which like references indicate similar elements. The embodiments, together with its advantages, may be best understood from the following detailed description taken in conjunction with the accompanying drawings.

FIG. 1 is an exemplary representation of an overview of a system to perform relative trend analysis for a business scenario, according to an embodiment.

FIG. 2 is an exemplary illustration of a user interface including a trend associated with a business scenario, according to an embodiment.

FIG. 3 is a flow diagram illustrating a method for performing a relative trend analysis for a business scenario, according to an embodiment.

FIG. 4 is a block diagram illustrating an overview of a system to perform a relative trend analysis of a business scenario, according to an embodiment.

FIG. 5A is an exemplary illustration of a user interface to perform a first-level relative trend analysis of a business scenario, according to an embodiment.

FIG. 5B is an exemplary illustration of a user interface including related business objects of a first-level trend analysis of a business scenario, according to an embodiment.

FIG. 5C is an exemplary illustration of a user interface to perform second-level of relative trend analysis of a business scenario, according to an embodiment.

FIG. 5D is an exemplary illustration of a user interface to perform third-level of relative trend analysis of a business scenario, according to an embodiment.

FIG. 6 is a block diagram of an exemplary computer system.

### DETAILED DESCRIPTION

Embodiments of techniques for systems and methods to perform relative trend analysis for a scenario are described herein. In the following description, numerous specific details are set forth to provide a thorough understanding of the embodiments. One skilled in the relevant art will recognize, however, that the embodiments can be practiced without one or more of the specific details, or with other methods, components, materials, etc. In other instances, well-known structures, materials, or operations are not shown or described in detail.

Reference throughout this specification to “one embodiment”, “this embodiment” and similar phrases, means that a particular feature, structure, or characteristic described in connection with the embodiment is included in at least one of the one or more embodiments. Thus, the appearances of these phrases in various places throughout this specification are not necessarily all referring to the same embodiment. Furthermore, the particular features, structures, or characteristics may be combined in any suitable manner in one or more embodiments.

A business scenario represents circumstances based on assumptions and predictions from past and present business information associated with it. The information is aggregated over a period of time and is represented in the form of a trend. A trend is hence a statistically quantifiable movement of an entity as a function of a measure, for example time The analysis of the trend includes examining related internal and external factors affecting the trend. The information represents business data of the business scenario, and may be residing in business objects. The internal or external factors affecting the business scenario include business objects, herein referred to as “related business objects” corresponding to related business scenarios. A user performs a relative trend analysis on one of the business scenarios to determine related business objects that affect the business scenario. The results of the relative trend analysis are rendered as a graphical illustration of the trend of the business scenario under analysis and trends corresponding to the related business scenarios.

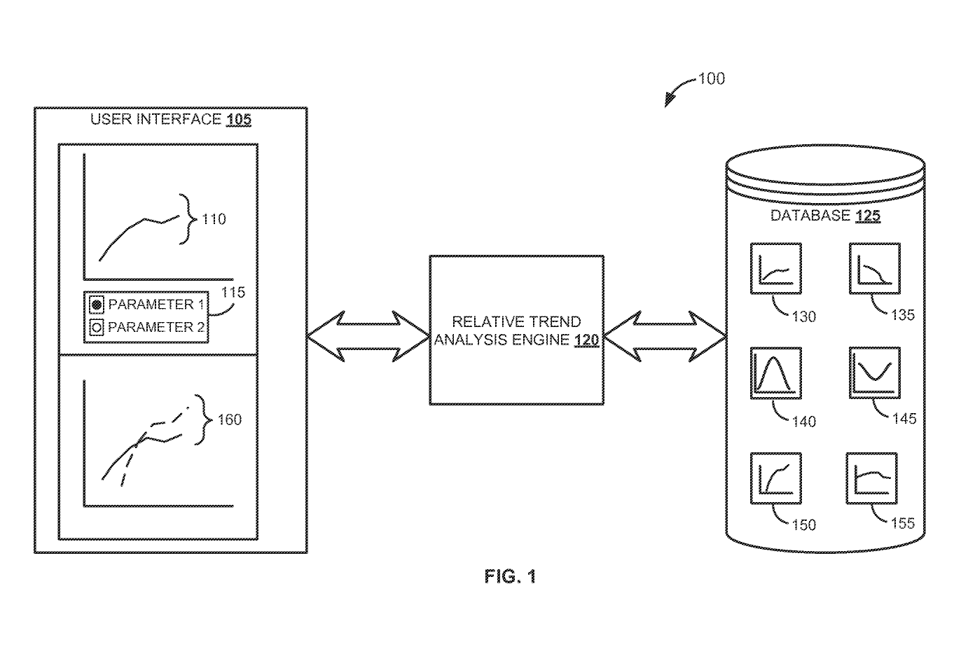

FIG. 1 is an exemplary representation of an overview of a system to perform relative trend analysis for a business scenario, according to an embodiment. In an embodiment, a relative trend analysis system 100 includes a user interface (UI) 105, a relative trend analysis engine 120, and a database 125. Business objects 130, 135, 140, 145, 150 and 155 associated with a plurality of business scenarios may reside in the database 125. The business objects 130, 135, 140, 145, 150 and 155 include business data aggregated over a period of time, which may be represented in the form of trends. The business scenario may be associated with parameters that represent analysis criteria of the scenario, based upon which the relative trend analysis is performed. In an embodiment, a graphical illustration of a trend 110 and parameters 115 associated with the business scenario are rendered on the UI 105. A user performing a relative trend analysis may select parameters 115 to perform the analysis. Based on the user selection, the relative trend analysis engine 120 matches the trend of the business scenario under analysis with one or more trends of the other business scenarios, herein referred to as gradients. Based on matching the trend with the gradients, related business objects 130, 135, 140, 145, 150 and 155 of related business scenarios are determined. The relative trend analysis engine 120 renders a graphical illustration of the trends 110 of the business scenario and the gradients 160 of the related business scenarios. In another embodiment, the database 125 may include a plurality of business objects 130, 135, 140, 145, 150 and 155 associated with a plurality of business scenarios. In an embodiment, the related business objects 130, 135, 140, 145, 150 and 155 include impacting business objects or impacted business objects. When the business objects of the business scenario under analysis are affected by the related business objects, they are referred to as impacted business objects. When the business objects of the business scenario under analysis are affecting the related business objects, they are referred to as impacting business objects. Hence the impacted business objects provide an insight on the factors that were affected by the business scenario under analysis, while the impacting business objects provide an insight on factors affecting the business scenario under analysis.

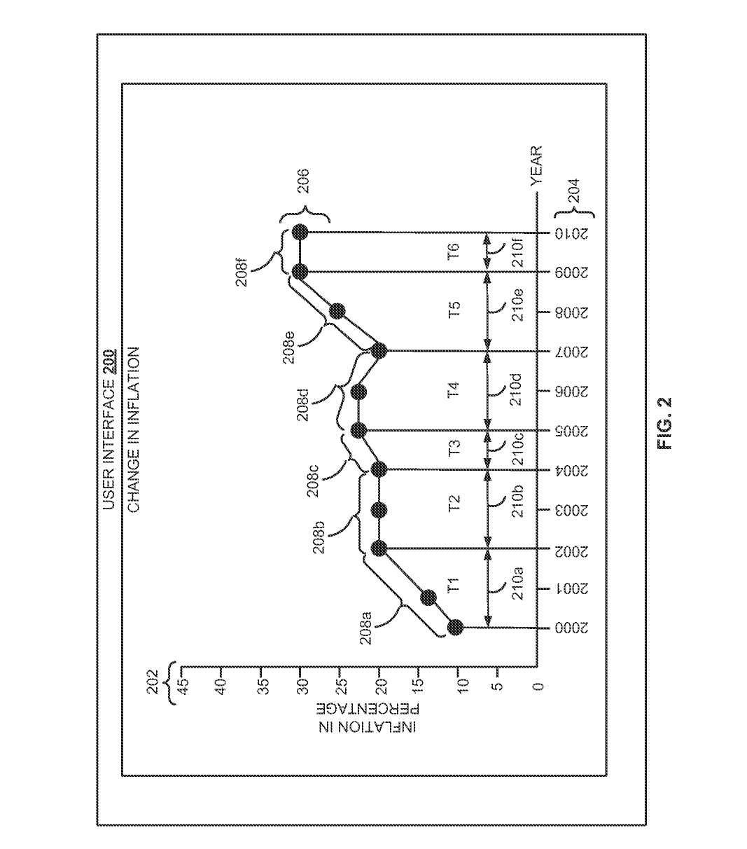

FIG. 2 is an exemplary illustration of a user interface including a trend associated with a business scenario, according to an embodiment. Consider a business scenario INFLATION that includes a percentage “change in inflation” as a function of time. The percentage “change in Inflation” represents business data included in business objects associated with the scenario Inflation. The percentage “change in inflation” represents a trend 206 and is rendered on the UI 200. The percentage “change in Inflation” is represented along the vertical axis (y-axis) 202 and a corresponding time frame during which the percentage change in inflation is recorded is represented along the horizontal axis (x-axis) 204. To perform a relative trend analysis, the trend associated with the percentage “change in Inflation” is split to obtain trend-splits. The trend is split based on a change in quotient of ratio of adjacent values associated with the trend,

For instance, consider the percentage “change in Inflation” including values between 5 and 45 represented as 202 on y-axis, for a time frame between 2000 and 2010 represented as 204 on x-axis. In the part of the trend representing the values 10, 14, 20 and 20 of the percentage change in inflation, the ratio of change in adjacent values is computed. The quotient of ratio of 14 and 10 is computed to be equal to 1.4; the quotient of ratio of 20 and 14 is computed to be equal to 1.42; and the quotient of ratio of 20 and 20 is computed to be equal to 1. It can be observed that there is no significant change in the quotient values 1.4 and 1.42. However, there is a significant change in the quotient values between 1.42 and 1. Hence the part of the trend representing the values 10, 14 and 20 is split to obtain a first trend-split 208a. Similarly, in the part of the trend representing the values 20, 20 and 20, the quotient of ratio is computed to be equal to 1. Hence the part of the trend representing the values 20, 20 and 20 is split to obtain a second trend-split 208b. In a similar manner the entire trend for the change in inflation may be split to obtain a plurality of trend-splits 208c, 208d, 208e and 208f. In an embodiment, the ratio of adjacent values may increase, representing a positive trend. In another embodiment, the ratio of adjacent values may decrease, representing a negative trend.

In an embodiment, data points at which the intervals of the time frame are split may be referred to as split-coefficients. The time frame 2000-2010 204 associated with trend 206 is split to obtain split-intervals T1 210a, T2 210b, T3 210c, T4 210d, T5 210e and T6 210f representing intervals corresponding to the trend-splits 208a, 208b, 208c, 208d, 208e and 208f. Thus trend-split 208a corresponds to the percentage change in inflation between a time frame 2000 and 2002, represented as TI 210a. Similarly the trend-splits 208b-208f corresponds to percentage change in inflation between the respective time frames T2-76 210b-210f. In an embodiment, the gradients representing corresponding trends of other business scenarios in the database may be split to generate a plurality of gradient-splits. The corresponding time frame associated with the gradient may be split to generate a plurality of split-intervals, as explained above.

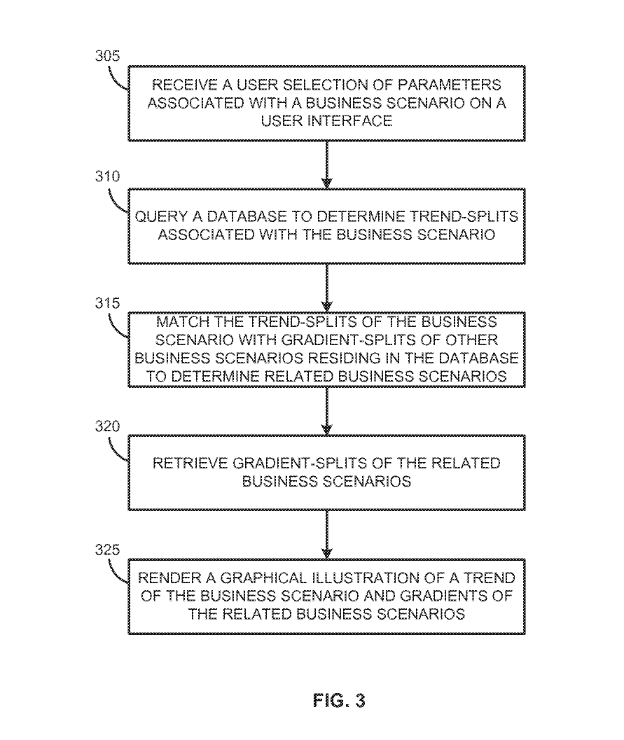

FIG. 3 is a flow diagram illustrating a method for performing a relative trend analysis for a business scenario, according to an embodiment. In an embodiment, a graphical illustration of a trend and parameters corresponding to a business scenario is rendered on a user interface (UI). A user performing a relative trend analysis may select parameters via the UI, at process block 305. Based upon the selected parameters, a database is queried to determine a plurality of trend-splits of the business scenario under analysis, at process block 310. At process block 315, the trend-splits of the business scenario under analysis are matched with gradient-splits of other business scenarios residing in the database. Based on the matching, related business scenarios are determined and the gradient-splits of the related business objects are retrieved from the database, at process block 320. In an embodiment, a related business scenario may include internal or external factors affecting the business scenario under analysis. A graphical illustration of the trend-splits representing trends of the business scenario under analysis and the gradient-splits representing gradients of related business scenarios are rendered on the UI, at process block 325.

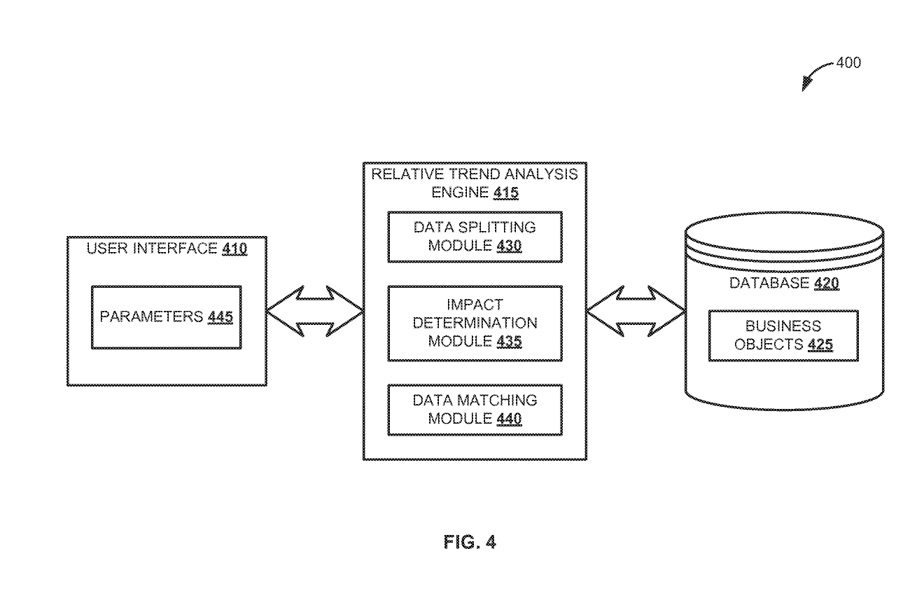

FIG. 4 is a block diagram illustrating an overview of a system to perform a relative trend analysis of a business scenario, according to an embodiment. In an embodiment, system 400 includes a user interface (UI) 410, a relative trend analysis engine 415, and a database 420, that are communicatively coupled to each other over a network (not shown) to perform relative trend analysis. Business objects 425 associated with a plurality of business scenarios may reside in the database 420. In another embodiment the database 420 includes an in-memory database which is operable to perform in-memory computations. In an embodiment, the user may load an existing business scenario representing business objects that may include business data corresponding to the business scenario aggregated over a period of time. Hence the business data may be represented in the form of a trend. In another embodiment, the user may generate a business scenario from business objects 425 that include business data of one or more business scenarios, for analysis.

For every business scenario, the relative trend analysis engine 415 identifies an established trend, and corresponding time frames. Based on the identified trends and the corresponding time frames associated with the business scenario, parameters 445 associated with the business scenario are rendered on the UI. The parameters 445 associated with the business scenario represent analysis criteria, based upon which the relative trend analysis is performed. The parameters 445 may include a measure name, a dimension name, a relation type, a degree of impact, and the like. The measure name parameter represents a group of quantifiable entities associated with the business scenario, for example Real Estate Prices. The dimension name parameter represents a time frame associated with the business scenario, for example, a Year or a Month. A relation type parameter represents an upward trend or a downward trend for a business object. For example, consider business object A corresponds to a time instant T1 and business object B corresponds to time instant T2. Business object B has a downward trend with respect to business object A, if business object B is impacted by business object A at an instant such that T2 is greater than T1. Business object B has an upward trend with respect to business object A, if business object B is impacted by business object A at an instant such that T1 is greater than T2.

In an embodiment, upon receiving a user selection of the parameters 445 via the UI 410, the relative trend analysis engine determines trend-splits associated with the business scenario and queries the database 420 to determine related data for analysis. The related data may include business objects 425 of other business scenarios. In an embodiment, a data splitting module 430 of the relative analysis engine 415 splits the trend associated with the business scenario to obtain the trend-splits, as explained in detailed description of FIG. 2. An impact determination module 435 determines a degree of impact associated with the business object. A degree of impact represents a degree of effect that the impacting or the impacted business object induces on the business scenario. For example, consider the user selection of the parameter “a degree of impact in a range of 100%-80% for matching trends”; for such a selection, business objects that may be impacted by or may be impacting other business objects in the range of 100%-80% are identified for analysis. Similarly, if the user selects “a degree of impact in the range of 80%-60% matching trends” as the parameter, the business objects that are impacted by or that are impacting other business objects in the range of 80%-60% are identified for analysis.

In an etribodintent, the gradient includes positive gradient representing ascending values of the business object and negative gradient representing descending values of the business object. In an embodiment, the business object 425 includes linear values, and the associated gradient represents a linear gradient. In another embodiment, the business object 425 includes logarithmic values, and the associated gradient representing logarithmic gradient.

The relative trend analysis engine 415 may store a reference to the trend-splits of the business scenario and a reference to the gradient-splits of other business scenarios by generating an index for each trend-split and gradient-split. A data matching module 110 of the relative trend analysis engine 415 matches the trend-splits of the business scenario under analysis with gradient-splits of the other business scenarios. Matching may include matching the positive trend-splits of the business scenario with the positive gradient-splits or the negative gradient-splits of the other business scenarios. Matching may also include matching the negative trend-splits of the business scenario with the positive gradient-splits or the negative gradient-splits of the other business scenarios. A process of matching includes correlating trend-splits of the business scenario under analysis with the gradient-splits of the business scenarios residing in the database. The trend-splits of the business scenarios under analysis, having a similar pattern of change in the trend, or change in a quotient of ratio between adjacent values are determined and matched with the gradient-splits of other business scenarios. In an embodiment, the change in quotient of ratio between adjacent values for trends and gradients may include positive values or negative values.

Based on the matching trend-splits of the business scenario under analysis and the gradient-splits of the other business scenarios residing in the database 420, related business objects 425 of related business scenarios are determined and retrieved from the database 420 by the relative trend analysis engine 415. A graphical illustration of the trend-splits represents a trend of the business scenario under analysis and the gradient-splits representing gradients of the related business scenarios is rendered on the UI 410. In an embodiment, the graphical illustration rendered includes related business objects of the related business scenarios. The related business objects 425 which are rendered on the UI may represent the impacted and the impacting business objects. Thus the graphical illustration provides a first-level analysis of the business scenario based on the selected parameters, and provides insights on the affecting factors associated with the business scenario under analysis.

In an embodiment, system 400 includes a second-level analysis UI 110 component. The second-level analysis UI 410 component helps the user to perform the relative trend analysis by narrowing the scope of a first-level analysis and providing a next level characterization and the related business objects affecting the business scenario under analysis. Hence the second-level analysis is performed by the user based on the first-level analysis. In an embodiment, the relative trend analysis engine 415 of the system 400 generates the second-level analysis UI 410 component to determine a second set of related business objects 425. The second-level analysis 410 component is rendered on UI 410 that includes the graphical illustration of the trend of the business scenario under analysis and the gradient of first related business scenarios including the impacted or impacting business objects 425. Based on the first-level analysis of the business scenario and the first related business scenarios, the relative trend analysis engine 415 determines second related business scenarios, as explained above. The relative trend analysis engine 415 retrieves the gradient-splits of the second business scenarios and renders it on the UI 410. The graphical illustration includes the trend of the business scenario under analysis, gradients of the first related business scenarios and gradients of the second related business scenarios, including the impacting and the impacted business objects of the first related business scenarios and impacting and impacted business objects of the second related business scenarios.

In an embodiment, system includes a third-level analysis UI 410 component, also referred to as point-level analysis. The relative trend analysis engine 415 generates a third-level analysis UI 410 component that helps the user perform the relative trend analysis by narrowing the second-level scope of analysis to a specific time frame. The third-level analysis UI 410 component may include parameters 445 corresponding to a specific time frame, and measures associated the business scenario. The parameters 445 for third-level analysis may include an all-time high parameter, an all-time low parameter, a major fluctuations parameter, and a matching-trends parameter. The all-time high parameter indicates a maximum possible value for an entity in the business scenario. The all-time low parameter indicates a minimum possible value for an entity in the business scenario. The major fluctuations parameter indicates major fluctuations in values for an entity in the business scenario. The matching-trends parameter indicates similar trends for an entity in the business scenario. The specific time frame parameter corresponds to specific instants of time of the business scenario. In an embodiment, multiple-levels of relative trend analysis may be performed to obtain specific insights about the affecting factors associated with the business scenario under analysis.

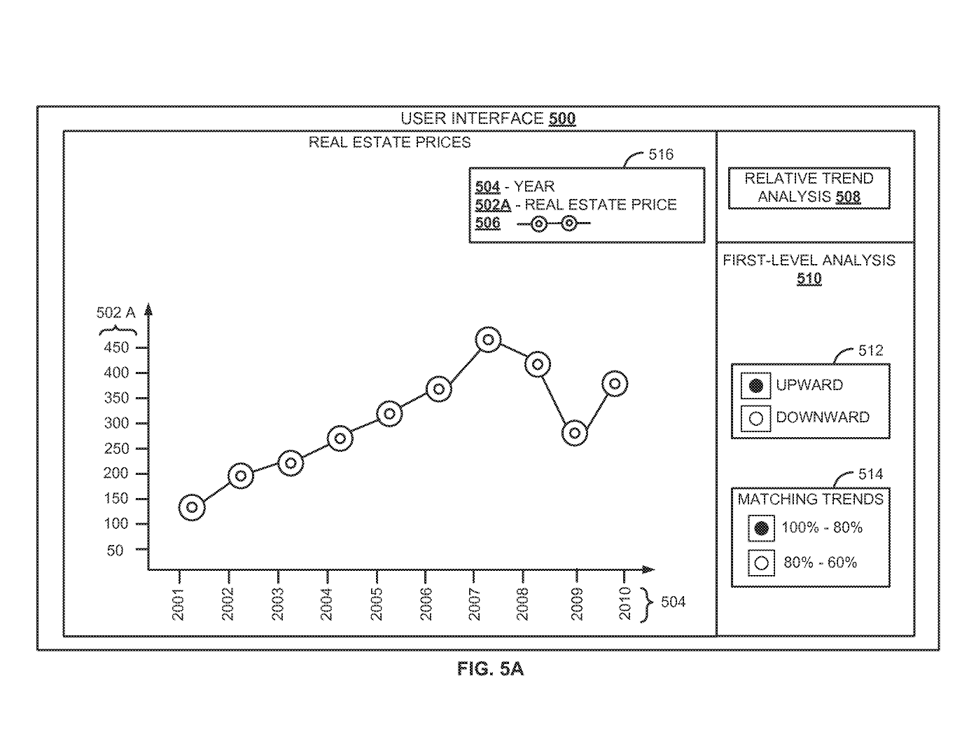

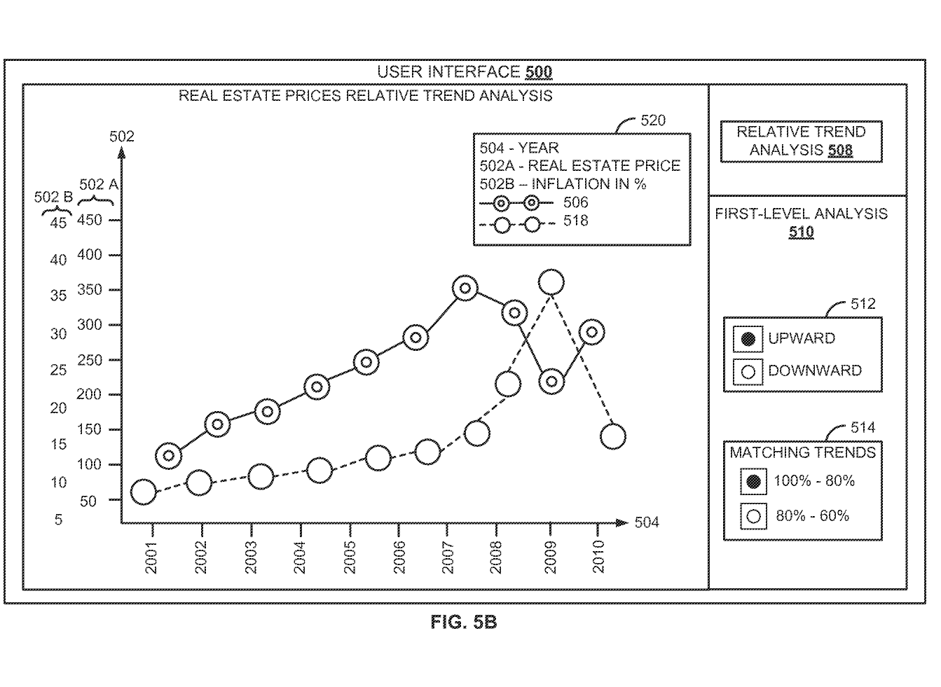

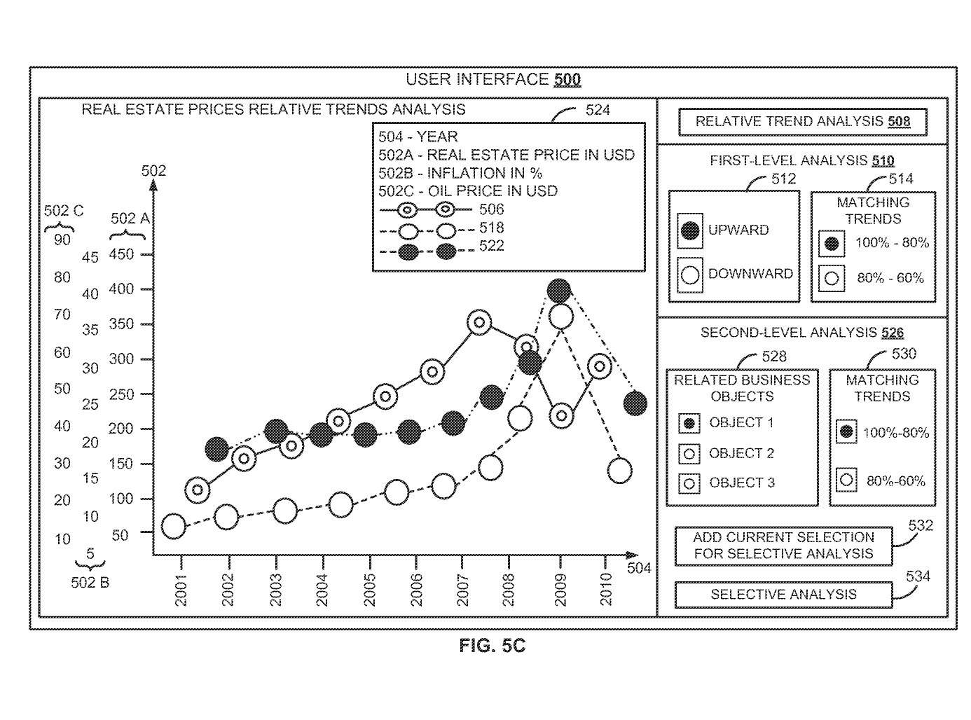

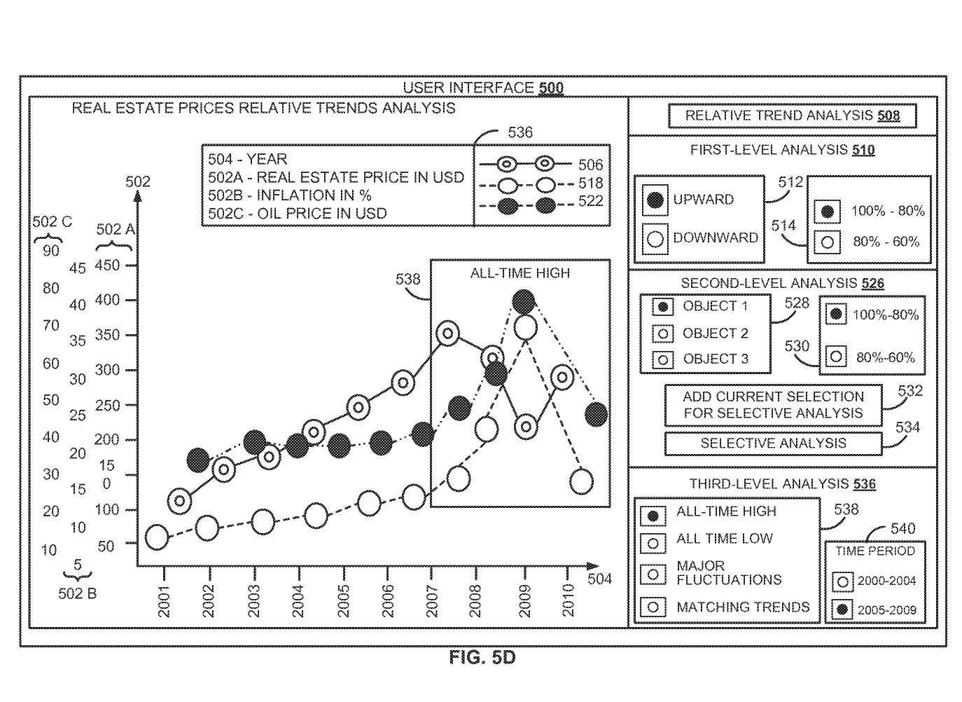

FIG. 5A is an exemplary illustration of a user interface to perform a first-level relative trend analysis of a business scenario, according to an embodiment. In an embodiment, the business scenario includes a “change in Real Estate Prices” that establishes a trend 506 as a function of time. As exemplarily illustrated in FIG. 5A, the “change in Real Estate Prices” is represented along the vertical axis (y-axis) 502A and the corresponding time frames are represented along the horizontal axis (x-axis) 504. A user performing the relative trend analysis for the “change in Real Estate Prices” triggers a relative trend analysis button 508, rendered along with a first-level analysis UI component 510. The relative trend analysis engine 415 determines the parameters associated with the “change in Real Estate Prices”. The first-level analysis UI component 510 renders the determined parameters that include a relation type parameter 512 and a degree of impact parameter 514. The relation type parameter 512 includes an upward trend or a downward trend associated with the “change in Real Estate Prices”, and the degree of impact parameter 514 includes 100%-80% or 80%-60% matching trend. Legend 516 provides a reference to the rendered trend 506, the corresponding time frames 504, and the real estate prices 502A.

FIG. 5B is an exemplary illustration of a user interface including related business objects of a first-level trend analysis of a business scenario, according to an embodiment, in an embodiment, the relative trend analysis engine 415 performs relative trend analysis, as explained in detailed description of FIG. 4, for the “change in Real Estate Prices”. The user selected “Upward analysis” for the parameter 512 and “100%-80%” for the parameter 514 in FIG. 5A. Based on the selected parameters, the relative trend analysis engine 415 determines the related business scenario “percentage change in Inflation”. The “percentage change in Inflation” is represented on the vertical axis (y-axis) 502B as related business scenario. The gradient-splits of gradient 518, associated with the “percentage change in inflation” are retrieved. A graphical illustration of the trends corresponding to a “change in Real Estate Prices” 506 and gradient corresponding to a “percentage change in Inflation” 518 as the function of time is rendered on the UI 500 in FIG. 5B. Legend 520 provides a reference to the rendered trend 506, the corresponding time frames 504, percentage change in inflation 502B and the real estate prices 502A.

FIG. 5C is an exemplary illustration of a user interface to perform second-level of relative trend analysis of a business scenario, according to an embodiment. In an embodiment, the UI 500 renders a graphical illustration of the trends corresponding to “change in Real Estate Prices” 506, and the gradients corresponding to the related business scenario “percentage change in Inflation” 518 determined during a first-level analysis. The “change in Real Estate Prices” and the percentage “change in Inflation” are represented along the vertical axis (y-axis) 502A and 502B and the corresponding time frames is represented along the horizontal axis (x-axis) 504. A second-level analysis UI component 526 that is rendered on the UI 500 helps the user to perform the relative trend analysis by narrowing the scope of a first-level analysis. The second-level analysis UI component 526 renders the first set of related business objects 528 and the parameter-degree of impact 530 as parameters for the second-level analysis.

The user selection of the second-level analysis parameters including “Object 1” for the parameter 528 and “100%-80%” for the parameter 530 are received and a “add current selection for selective analysis button” 532 is triggered. Upon triggering a selective analysis button 534, the relative trend engine 415 determines the gradient-splits of the first related business scenario “percentage change in Inflation”. Based on the user selection of “Object 1” for parameter 528, the relative trend analysis engine 415 determines related business scenario as “change in Oil Prices” and retrieves the gradient-splits of related business scenario “change in Oil Prices”, by matching the gradient-splits of the “change in Oil Prices” with the gradient-splits of “percentage change in Inflation”, as explained in detailed description of FIG. 4. A graphical illustration of the trend of “change in Real Estate Prices” 506, gradient of the “percentage change in Inflation” 518 and gradient of the “change in Oil Prices” 522 are rendered on the UI 500. Legend 524 provides a reference to the rendered trend 506, trend corresponding to real estate prices 518, trend corresponding to oil prices 522, the corresponding time frames 504, the percentage change in inflation 502B, the change in oil prices 502C and the real estate prices 502A.

FIG. 5D is an exemplary illustration of a user interface to perform third-level of relative trend analysis of a business scenario, according to an embodiment. A third-level analysis narrows the scope of the second-level analysis by further performing analysis on the available related business objects from the first and the second level analysis. For instance, a third level analysis may include narrowing analysis for a user to predict a “change in Real Estate Prices” for the year 2013 based upon the analysis performed for “change in Real Estate Prices” 506, “percentage change in Inflation” 518 and “change in Oil Prices” 522 determined in first and second level analysis.

Upon rendering an illustration of the second level analysis on the UI 500 in FIG. 5D, a third-level analysis UI component 536 may be triggered by the relative trend analysis engine 415 to perform the third-level analysis. Triggering the third level analysis UI component 536 generates a plurality of third-level analysis parameters 538 and 540. Upon a user selection of one or more of the third-level analysis parameter, a resulting analysis may be rendered on the UI of FIG. 5D. The third-level analysis parameter 538 may include an All-time High parameter, an All-time Low parameter, a Major Fluctuations parameter, and a Matching-trends parameter. The All-time High parameter indicates a maximum possible value of the measure for the business scenario. The All-time Low parameter indicates a minimum possible value of the measure for the business scenario. The Major Fluctuations parameter indicates major fluctuations of measures in the business scenario. The Matching-trends parameter indicates similar trend patterns for the measures in the business scenario. The Time Period parameter corresponds to specific instants of time of the business scenario.

The user may select “All-time High” for the 538 parameter and “2005-2009” for the 510 parameter for the third-level analysis. As a result of the user selection, the relative trend analysis engine 415 narrows the scope of analysis and highlights the results of the third-level analysis by visually indicating the results of the third-level analysis. A visual indication 538 including an all-time high value of all the rendered trends 506, 518 and 522 (for example, the business scenario under analysis, the first related business scenario, and the second related business scenario) for the period 2005-2009 is rendered on the 500. By performing such relative trend analysis on the trend 508 associated with business scenario under analysis, the impacting or impacted business objects can be identified. Legend 536 provides a reference to the rendered trends of business scenario 506 and gradients of related business scenarios 518, 522, the corresponding time frames 504, Real Estate Prices 502A, the percentage change in Inflation 502B, and the change in Oil Prices 502C.

Some embodiments may include the above-described methods being written as one or more software components. These components, and the functionality associated with each, may be used by client, server, distributed, or peer computer systems. These components may be written in a computer language corresponding to one or more programming languages such as, functional, declarative, procedural, object-oriented, lower level languages and the like. They may be linked to other components via various application programming interfaces and then compiled into one complete application for a server or a client. Alternatively, the components maybe implemented in server and client applications. Further, these components may be linked together via various distributed programming protocols. Some example embodiments may include remote procedure calls being used to implement one or more of these components across a distributed programming environment. For example, a logic level may reside on a first computer system that is remotely located from a second computer system containing an interface level (e.g., a graphical user interface). These first and second computer systems can be configured in a server-client, peer-to-peer, or some other configuration. The clients can vary in complexity from mobile and handheld devices, to thin clients and on to thick clients or even other servers.

The above-illustrated software components are tangibly stored on a computer readable storage medium as instructions. The term “computer readable storage medium” should be taken to include a single medium or multiple media that stores one or more sets of instructions. The term “computer readable storage medium” should be taken to include any physical article that is capable of undergoing a set of physical changes to physically store, encode, or otherwise carry a set of instructions for execution by a computer system which causes the computer system to perform any of the methods or process steps described, represented, or illustrated herein. Examples of computer readable storage media include, but are not limited to: magnetic media, such as hard disks, floppy disks, and magnetic tape; optical media such as CD-ROMs, DVDs and holographic devices; magneto-optical media; and hardware devices that are specially configured to store and execute, such as application-specific integrated circuits (“ASICs”), programmable logic devices (“PLDs”) and ROM and RAM devices. Examples of computer readable instructions include machine code, such as produced by a compiler, and files containing higher-level code that are executed by a computer using an interpreter. For example, an embodiment may be implemented using Java, C++, or other object-oriented programming language and development tools. Another embodiment may be implemented in hard-wired circuitry in place of, or in combination with machine readable software instructions.

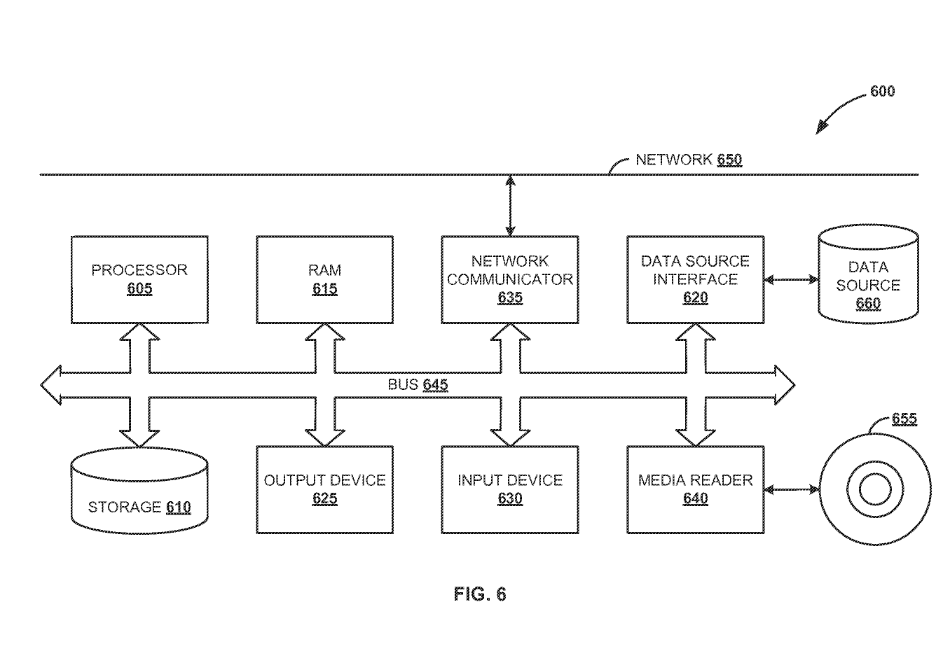

FIG. 6 is a block diagram of an exemplary computer system 600. The computer system 600 includes a processor 605 that executes software instructions or code stored on a computer readable storage medium 655 to perform the above-illustrated methods. The processor 905 can include a plurality of cores. The computer system 600 includes a media reader 640 to read the instructions from the computer readable storage medium 655 and store the instructions in storage 610 or in random access memory (RAM) 615. The storage 610 provides a large space for keeping static data where at least some instructions could be stored for later execution. According to some embodiments, such as some in-memory computing system embodiments, the RAM 615 can have sufficient storage capacity to store much of the data required for processing in the RAM 615 instead of in the storage 610. In some embodiments, all of the data required for processing may be stored in the RAM 615. The stored instructions may be further compiled to generate other representations of the instructions and dynamically stored in the RAM 615. The processor 605 reads instructions from the RAM 615 and performs actions as instructed. According to one embodiment, the computer system 600 further includes an output device 625 (e.g., a display) to provide at least some of the results of the execution as output including, but not limited to, visual information to users and an input device 630 to provide a user or another device with means for entering data and/or otherwise interact with the computer system 600. Each of these output devices 625 and input devices 630 could be joined by one or more additional peripherals to further expand the capabilities of the computer system 600. A network communicator 635 may be provided to connect the computer system 600 to a network 650 and in turn to other devices connected to the network 650 including other clients, servers, data stores, and interfaces, for instance. The modules of the computer system 600 are interconnected via a bus 645. Computer system 600 includes a data source interface 620 to access data source 660. The data source 660 can be accessed via one or more abstraction layers implemented in hardware or software. For example, the data source 660 may be accessed by network 650. In some embodiments the data source 660 may be accessed via an abstraction layer, such as, a semantic layer.

A data source is an information resource. Data sources include sources of data that enable data storage and retrieval. Data sources may include databases, such as, relational, transactional, hierarchical, multi-dimensional (e.g., OLAP), object oriented databases, and the like. Further data sources include tabular data (e.g., spreadsheets, delimited text files), data tagged with a markup language (e.g., XML data), transactional data, unstructured data (e.g., text files, screen scrapings), hierarchical data (e.g., data in a file system, XML data), files, a plurality of reports, and any other data source accessible through an established protocol, such as, Open DataBase Connectivity (ODBC), produced by an underlying software system (e.g., ERP system), and the like. Data sources may also include a data source where the data is not tangibly stored or otherwise ephemeral such as data streams, broadcast data, and the like. These data sources can include associated data foundations, semantic layers, management systems, security systems and so on.

In the above description, numerous specific details are set forth to provide a thorough understanding of embodiments. One skilled in the relevant art will recognize, however that the embodiments can be practiced without one or more of the specific details or with other methods, components, techniques, etc. In other instances, well-known operations or structures are not shown or described in detail.

Although the processes illustrated and described herein include series of steps, it will be appreciated that the different embodiments are not limited by the illustrated ordering of steps, as some steps may occur in different orders, some concurrently with other steps apart from that shown and described herein. In addition, not all illustrated steps may be required to implement a methodology in accordance with the one or more embodiments. Moreover, it will be appreciated that the processes may be implemented in association with the apparatus and systems illustrated and described herein as well as in association with other systems not illustrated.

The above descriptions and illustrations of embodiments, including what is described in the Abstract, is not intended to be exhaustive or to limit the one or more embodiments to the precise forms disclosed. While specific embodiments of, and examples for, the one or more embodiments are described herein for illustrative purposes, various equivalent modifications are possible within the scope, as those skilled in the relevant art will recognize. These modifications can be made in light of the above detailed description. Rather, the scope is to be determined by the following claims, which are to be interpreted in accordance with established doctrines of claim construction.

What is claimed is:

1. A computer implemented method to perform a relative trend analysis of a business scenario, comprising:
receiving a user selection of one or more parameters associated with a business scenario under analysis, rendered on a computer generated user interface;
based on the user selection, querying a database to determine one or more trend-splits of the business scenario under analysis;
based on a time frame associated with the trend-splits of the business scenario under analysis, a processor of the computer, matching the trend-splits of the business scenario under analysis with one or more gradient-splits of one or more business scenarios residing in the database, to determine one or more related business scenarios; and
rendering a graphical illustration of a trend of the business scenario under analysis and one or more gradients of the one or more related business scenarios on the computer generated user interface, by retrieving the gradient-splits of the one or more related business scenarios.

2. The computer implemented method of claim 1, wherein the trend of the business scenario under analysis is split based on a quotient of ratio between one or more adjacent values associated with the trend included in one or more business objects.

3. The computer implemented method of claim 1 further comprising:
splitting a time frame associated with the business objects to generate one or more split-intervals.

4. The computer implemented method of claim 1, wherein the gradient-splits of the one or more business scenarios associated with a time frame represent a gradient, including a positive gradient and a negative gradient.

5. The computer implemented method of claim 4, wherein the gradient includes:
a linear gradient representing one or more linear values of the one or more business scenarios; and
a logarithmic gradient representing one or more logarithmic values of the one or more business scenarios.

6. The computer implemented method of claim 1, wherein the related business scenarios include one or more related business objects representing one or more impacted business objects and one or more impacting business objects.

7. The computer implemented method of claim 1, wherein matching the trend-splits with the gradient-splits includes: correlating a positive trend and a negative trend of the business scenario under analysis with corresponding one or more positive gradients and one or more negative gradients of the one or more business scenarios.

8. The computer implemented method of claim 1 further comprising:
a first-level analysis user interface component to perform the relative trend analysis for the business scenario under analysis;
a second-level analysis user interface component to narrow a scope of the first-level analysis; and
a third-level analysis user interface component to narrow a scope of the second-level analysis.

9. The computer implemented method of claim 1, wherein the user selection of the parameters comprises a selection of a degree of impact parameter and a relation type parameter.

10. A computer implemented system to perform a relative trend analysis for a scenario comprising:
a processor operable for reading and executing instructions stored in one or more memory elements; and
a user input device configured to receive a user selection of one or more parameters associated with a business scenario under analysis on a user interface;
the one or more memory elements storing instructions for:
a relative trend engine configured to:
query a database and determine one or more of trend-splits associated with the business scenario under analysis; and
match the trend-splits of the business scenario under analysis with one or more gradient-splits of the one or more business scenarios residing in the database to determine one or more related business scenarios; and
an output device to render a graphical illustration of a trend of the business scenario under analysis and one or more gradients of the business scenarios by retrieving the gradient-splits of the one or more related business scenarios.

11. The computer system of claim 9 further comprising: a data splitting module to:
split a trend of the business scenario under analysis to generate one or more trend-splits; and
split a gradient of the one or more business scenarios residing in the database to generate one or more gradient-splits.

12. The computer system of claim 9 further comprising:
a data matching module to match the trend-splits of the business scenario with one or more gradient-splits of one or more business scenarios residing in the database.

13. The computer system of claim 9 further comprising:
an impact determination module to determine a degree of impact associated with a business object.

14. An article of manufacture including a non-transitory computer readable storage medium to tangibly store instructions, which when executed by a computer, cause the computer to:
receive a user selection of one or more parameters associated with a business scenario under analysis rendered on a computer generated user interface;
based on the user selection, query a database to determine one or more trend-splits of the business scenario under analysis;
based on a time frame associated with the trend-splits of the business scenario under analysis, match the trend-splits of the business scenario under analysis with one or more gradient-splits of one or more business scenarios residing in the database to determine one or more related business scenarios; and
render a graphical illustration of a trend of the business scenario under analysis and one or more gradients of one or more related business scenarios by retrieving the gradient-splits of one or more related business scenarios.

15. The article of manufacture of claim 14, wherein the trend of the business scenario under analysis is split based on a quotient of ratio between one or more adjacent values associated with the trend included in one or more business objects.

16. The article of manufacture of claim 14 further comprising instructions to:
split a time frame associated with the business objects to generate one or more split-intervals.

17. The article of manufacture of claim 14, wherein the gradient-splits of the one or more business scenarios associated with a time frame represent a gradient, including a positive gradient and a negative gradient.

18. The article of manufacture of claim 14, wherein the gradient includes:
a linear gradient representing one or more linear values of the one or more business scenarios; and
a logarithmic gradient representing one or more logarithmic values of the one or more business scenarios.

19. The article of manufacture of claim 14, wherein the related business scenarios include one or more related business objects representing one or more impacted business objects and one or more impacting business objects.

20. The article of manufacture of claim 14, wherein matching the trend-splits with the gradient-splits includes:
correlating a positive trend and a negative trend of the business scenario under analysis with corresponding one or more positive gradients and one or more negative gradients of the one or more business scenarios.
